(19) United States
(12) Patent Application Publication
(10) Pub. No.: US 2020/0145973 A1
(43) Pub. Date: May 7, 2020

(54) INFORMATION TRANSMISSION METHOD, APPARATUS AND TERMINAL

(71) Applicant: GUANGDONG OPPO MOBILE TELECOMMUNICATIONS CORP., LTD., Dongguan (CN)

(72) Inventor: Yanan LIN, Dongguan (CN)

(73) Assignee: GUANGDONG OPPO MOBILE TELECOMMUNICATIONS CORP., LTD., Dongguan (CN)

(21) Appl. No.: 16/738,918

(22) Filed: Jan. 9, 2020

Related U.S. Application Data
(63) Continuation of application No. PCT/CN2018/106520, filed on Sep. 19, 2018.

(51) Int. Cl. H04W 72/04; H04L 1/18

(52) U.S. Cl. CPC H04W 72/042; H04L 1/1812

(57) ABSTRACT

Embodiments of the present application provide an information transmission method, an apparatus, and a terminal. The method includes: a terminal receives first configuration information, and determining, based on the first configuration information, that multiple time units are used to transmit one downlink data channel in at least one carrier; and the terminal receives first downlink control information, where the first downlink control information carries first indication information and/or second indication information, where the first indication information is used to indicate an accumulative number of downlink data channels received by the terminal that have different data content and/or an accumulative number of DCI indicating downlink SPS resource release, and the second indication information is used to indicate a total number of downlink data channels received by the terminal that have different data content and/or a total number of DCI indicating downlink SPS resource release.

### CROSS-REFERENCE TO RELATED APPLICATIONS

This application is a continuation of International Application No. PCT/CN2018/106520, filed on Sep. 19, 2018, which is hereby incorporated by reference in its entirety.

### TECHNICAL FIELD

Embodiments of the present application relate to the field of mobile communication technologies and, in particular, to an information transmission method, apparatus, and terminal.

### BACKGROUND

In a 5^{th} Generation (5G)-New Radio (NR) system, dynamically indicating feedback timing of feedback response information (briefly as HARQ timing) is supported for a physical downlink shared channel (PDSCH). In addition, the NR system supports multiplexing transmission of the feedback response information (such as ACK/NACK), that is, feedback response information corresponding to multiple PDSCHs is transmitted over one physical uplink control channel (PUCCH).

When a terminal is configured by a network side to dynamically determine the number of bits of the feedback response information, the terminal determines a feedback response information sequence based on a downlink assignment indicator (DAI) information field in Downlink Control Information (DCI). However, according to the current definition of DAI, uplink control overheads will be significantly increased. In some cases, there will also be a misunderstanding between a base station and user equipment (UE) with regard to the number of bits of the feedback response information, which seriously affects system performance.

### SUMMARY

Embodiments of the present application provide an information transmission method, an apparatus, and a terminal:

An information transmission method provided in an embodiment of the present application includes:

receiving, by a terminal, first configuration information, and determining, based on the first configuration information, that multiple time units are used within at least one carrier to transmit one downlink data channel; and

receiving, by the terminal, first downlink control information, wherein the first downlink control information carries first indication information and/or second indication information, wherein the first indication information is used to indicate an accumulative number of downlink data channels received by the terminal that have different data content and/or an accumulative number of downlink control information (DCI) indicating downlink semi-persistent scheduling (SPS) resource release, and the second indication information is used to indicate a total number of downlink data channels received by the terminal that have different data content and/or a total number of DCI indicating downlink SPS resource release, and wherein feedback response information corresponding to the downlink data channels having different data content and/or the DCI indicating the downlink SPS resource release is transmitted in a multiplexed manner over one physical channel.

An information transmission method provided in an embodiment of the present application includes:

transmitting, by a network device, first configuration information, wherein the first configuration information is used by a terminal to determine that multiple time units are used to transmit one downlink data channel in at least one carrier; and

transmitting, by the network device, first downlink control information, wherein the first downlink control information carries first indication information and/or second indication information, wherein the first indication information is used to indicate an accumulative number of downlink data channels received by the terminal that have different data content and/or an accumulative number of DCI indicating downlink SPS resource release, and the second indication information is used to indicate a total number of downlink data channels received by the terminal that have different data content and/or a total number of DCI indicating downlink SPS resource release, and wherein feedback response information corresponding to the downlink data channels having different data content and/or the DCI indicating the downlink SPS resource release is transmitted in a multiplexed manner over one physical channel.

An information transmission apparatus provided in an embodiment of the present application includes:

a first receiving unit, configured to receive first configuration information, and determine, based on the first configuration information, that multiple time units are used to transmit one downlink data channel in at least one carrier; and

a second receiving unit, configured to receive first downlink control information, wherein the first downlink control information carries first indication information and/or second indication information, wherein the first indication information is used to indicate an accumulative number of downlink data channels received by a terminal that have different data content and/or an accumulative number of DCI indicating downlink SPS resource release, and the second indication information is used to indicate a total number of downlink data channels received by the terminal that have different data content and/or a total number of DCI indicating downlink SPS release, and wherein feedback response information corresponding to the downlink data channels having different data content and/or the DCI indicating the downlink SPS resource release is transmitted in a multiplexed manner over one physical channel.

An information transmission apparatus provided in an embodiment of the present application includes:

a first transmitting unit, configured to transmit first configuration information, wherein the first configuration information is used by a terminal to determine that multiple time units are used to transmit one downlink data channel in at least one carrier; and

a second transmitting unit, configured to transmit first downlink control information, wherein the first downlink control information carries first indication information and/or second indication information, wherein the first indication information is used to indicate an accumulative number of downlink data channels received by the terminal that have different data content and/or an accumulative number of DCI indicating downlink SPS resource release, and the second indication information is used to indicate a total number of downlink data channels received by the terminal that have different data content and/or a total number of DCI indicating downlink SPS resource release, and wherein feedback response information corresponding to the downlink data channels having different data content and/or the DCI indicating the downlink SPS resource release is transmitted in a multiplexed manner over one physical channel.

A terminal provided in an embodiment of the present application includes: a processor and a memory. The memory is configured to store a computer program, and the processor is configured to invoke and run the computer program stored in the memory to perform the information transmission method described above.

A network device provided in an embodiment of the present application includes: a processor and a memory. The memory is configured to store a computer program, and the processor is configured to invoke and run the computer program stored in the memory to perform the information transmission method described above.

A chip provided in an embodiment of the present application is configured to implement the information transmission methods described above.

Specifically, the chip includes: a processor configured to invoke and run a computer program from a memory such that a device on which the chip is mounted performs the information transmission methods described above.

A computer readable storage medium provided in an embodiment of the present application is configured to store a computer program which causes a computer to perform the information transmission methods described above.

A computer program product provided in an embodiment of the present application includes a computer program instruction which causes a computer to perform the information transmission methods described above.

A computer program provided in an embodiment of the present application, which when running on a computer, causes the computer to perform the information transmission methods described above.

With the above technical solutions, a new DAI is designed, where the first indication information corresponds to a counter DAI, the second indication information corresponds to a total DAI, the accumulative number indicated by the first indication information is directed to downlink data channels having different data content and/or downlink control information DCI indicating SPS resource release, similarly, the total number indicated by the second indication information is directed to downlink data channels having different data content and/or downlink control information DCI indicating SPS resource release, in this way, uplink control overheads can be effectively saved, and the misunderstanding between a base station and a UE with regard to the number of bits of the feedback response information can be avoided.

### BRIEF DESCRIPTION OF DRAWING(S)

Drawings described herein are intended to provide a further understanding of the present application, which constitute a part of the present application. Illustrative embodiments of the present application and descriptions thereof are intended to explain the present application, but do not unduly limit the present application. In the drawings:

FIG. 1 is a schematic diagram of a communication system architecture according to an embodiment of the present application;

FIG. 2 is a schematic diagram 1 of a DAI according to an embodiment of the present application;

FIG. 3 is a schematic diagram 2 of a DAI according to an embodiment of the present application;

FIG. 4 is a schematic flowchart 1 of an information transmission method according to an embodiment of the present application;

FIG. 5 is a schematic diagram 3 of a DAI according to an embodiment of the present application;

FIG. 6 is a schematic flowchart 2 of an information transmission method according to an embodiment of the present application;

FIG. 7 is a schematic structural diagram 1 of an information transmission apparatus according to an embodiment of the present application;

FIG. 8 is a schematic structural diagram 2 of an information transmission apparatus according to an embodiment of the present application;

FIG. 9 is a schematic structural diagram of a communication device according to an embodiment of the present application;

FIG. 10 is a schematic structural diagram of a chip according to an embodiment of the present application; and

FIG. 11 is a schematic block diagram of a communication system according to an embodiment of the present application.

### DESCRIPTION OF EMBODIMENTS

The technical solutions in the embodiments of the present application will be described hereunder with reference to the accompanying drawings in the embodiments of the present application. Obviously, the described embodiments are only a part of embodiments of the present application, rather than all embodiments of the present application. All other embodiments obtained by persons of ordinary skill in the art based on the embodiments of the present application without any creative effort shall fall into the protection scope of the present application.

The technical solutions in the embodiments of the present application can be applied to various communication systems, such as a global system of mobile communication (GSM) system, a code division multiple access (CDMA) system, a wideband code division multiple access (WCDMA) system, a general packet radio service (GPRS), a long term evolution (LTE) system, an LTE frequency division duplex (FDD) system, an LTE time division duplex (TDD) system, a universal mobile telecommunication system (UMTS) or a worldwide interoperability for microwave access (WiMAX) communication system, or a 5G system, etc.

Exemplarily, FIG. 1 shows a communication system 100 applied in an embodiment of the present application. The communication system 100 may include a network device 110. The network device 110 may be a device that communicates with a terminal 120 (or referred to as a communication terminal, a terminal). The network device 110 may provide a particular geographic area with communication coverage and may communicate with a terminal located within the coverage. In an implementation, the network device 110 may be a base station (base transceiver station, BTS) in the GSM system or the CDMA system, or a base station (NodeB, NB) in the WCDMA system, or an evolved base station (evolutional Node B, eNB or eNodeB) in the LTE system, or a wireless controller in a cloud radio access network (CRAN), alternatively, the network device may be a mobile switching center, a relay station, an access point, a vehicle-mounted device, a wearable device, a hub, a switch, a network bridge, a router, a network side device in the 5G network, or a network device in a future evolutional public land mobile network (PLMN), etc.

The communication system 100 also includes at least one terminal 120 located within the coverage of the network device 110. “Terminals” as used herein include, but are not limited to, being connected via a wired line, such as connected via a public switched telephone network (PSTN), a digital subscriber line (DSL), a digital cable, a direct cable; and/or to another data connection/network; and/or via a wireless interface, such as a cellular network, a wireless local area network (WLAN), a digital television network such as a DVB-H network, a satellite network, an AM-FM broadcast transmitter; and/or to an apparatus of another terminal configured to receive/transmit a communication signal; and/or an internet of things (IoT) device. The terminals configured to communicate via the wireless interface may be referred to as “wireless communication terminals”, “wireless terminals” or “mobile terminals”. Examples of the mobile terminals include, but are not limited to, satellite or cellular phones; personal communications system (PCS) terminals that can combine cellular radio phones with data processing, fax, and data communication capabilities; and may include radio phones, pagers, Internet/Intranet accesses, Web browsers, memos, calendars, and/or PDAs for global positioning system (GPS) receivers; and conventional laptop and/or handheld receivers or other electronic apparatuses including radio phone transceivers. The terminals may refer to access terminals, user equipment (UE), subscriber units, subscriber stations, mobile stations, mobile platforms, remote stations, remote terminals, mobile devices, user terminals, terminals, wireless communication devices, user agents, or user devices. The access terminals may be cellular phones, cordless phones, session initiation protocol (SIP) phones, wireless local loop (WLL) stations, personal digital assistants (PDA), handheld devices with wireless communication functions, computing devices or other processing devices vehicle-mounted devices and wearable devices connected to wireless modems, terminals in the future 5G network, or terminals in the future evolutional PLMN, or the like.

In an implementation, device to device (D2D) communications may be performed between terminals 120.

In an implementation, the 5G system or the 5G network may also be referred to as a new radio (NR) system or an NR network.

FIG. 1 exemplarily shows one network device and two terminals. In an implementation, the communication system 100 may include multiple network devices and other number of terminals may be included within the coverage of each of the network devices, which is not limited in the embodiment of the present application.

In an implementation, the communication system 100 may further include other network entities, such as a network controller, a mobility management entity, which is not limited in the embodiment of the present application.

It should be understood that, in the embodiment of the present application, a device with a communication function in the network/system may be referred to as a communication device. Taking the communication system 100 shown in FIG. 1 as an example, the communication device may include a network device 110 and a terminal 120 having communication functions, while the network device 110 and the terminal 120 may be specific devices described above, and of which the details will not be described herein. The communication device may also include other devices in the communication system 100, for example, other network entities such as a network controller, a mobility management entity and the like, which are not limited in the embodiment of the present application.

It should be understood that the terms such as “system” and “network” herein are typically interchangeable herein. The term “and/or” herein is merely an association between associated objects, which indicates that there may be three relationships, for example, A and/or B may indicate that only A exists, both A and B exist and only B exists. In addition, the character “/” herein generally indicates that contextual associated objects have an “or” relationship.

In order to facilitate the understanding of the technical solutions in the embodiments of the present application, related technologies involved in the embodiments of the present application will be described below.

1. Feedback Timing of Feedback Response Information (HARQ Timing)

The terminal determines a pre-configured timing set including up to eight values {K1₀, K1₁, K1₂, K1₃, K1₄, K1₅, K1₆, K1₇}. A DCI schedules that a PDSCH is transmitted in a slot n, and a target information field of 3 bits included in the DCI is used to indicate a value K1ᵢ in the pre-configured set, then the terminal transmits ACK/NACK information corresponding to the PDSCH in a slot n+K1ᵢ. The pre-configured timing set corresponding to a DCI format 1_0 is constantly {1, 2, 3, 4, 5, 6, 7, 8}. For DCI format 1_1, values in the pre-configured timing set are configured by a higher layer parameter.

2. Multiplexing Transmission of ACK/NACK

ACK/NACK information corresponding to multiple PDSCHs is transmitted over one PUCCH. For multiplexing transmission of ACK/NACK, two ACK/NACK information generation modes are further supported: semi-statically determining the number of ACK/NACK bits (semi-static HARQ-ACK codebook) and dynamically determining the number of ACK/NACK bits (dynamic HARQ-ACK codebook). When it is configured to dynamically determine the number of ACK/NACK bits, the terminal determines a sequence of feedback information based on the DAI information field in the DCI. Further, there are two types of the DAI, one type is a counter DAI (briefly as DAI_{c}), and the other type is a total DAI (briefly as DAI_{T}). The counter DAI indicates the accumulative number of PDSCHs received on {serving cell, PDCCH monitoring occasion}-pair(s), where the serving cell can also be replaced with a carrier, and the PDCCH monitoring occasion can also be replaced with a time unit. One {serving cell, PDCCH monitoring occasion}-pair represents a target resource unit, on which a PDSCH can be transmitted.

3. Slot Aggregation

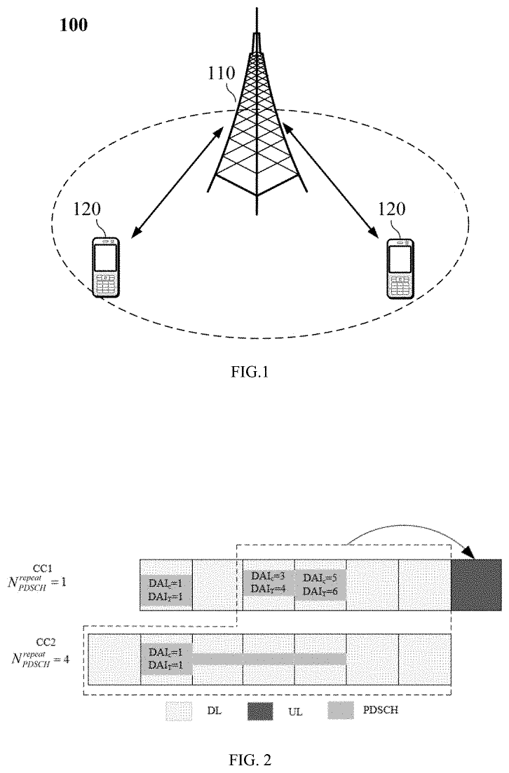

The NR system supports slot aggregation, that is, one transport block (TB) is repeatedly transmitted in consecutive time units, and the terminal then only supports single code-word transmission. As shown in FIG. 2, the upper row represents time units on a carrier 1 (CC1), where the number of PDSCH that is repeatedly transmitted on the CC1 is 1, that is, N_{PDSCH}^{repeat}=1; the lower row represents time units on a carrier 2 (CC2), where the number of PDSCHs that are repeatedly transmitted on the CC2 is 4, that is, N_{PDSCH}^{repeat}=4. According to the definition of DAI described above, the terminal needs to feedback 6 bits of ACK/NACK information in an uplink (UL) time unit, which significantly increases uplink control overheads.

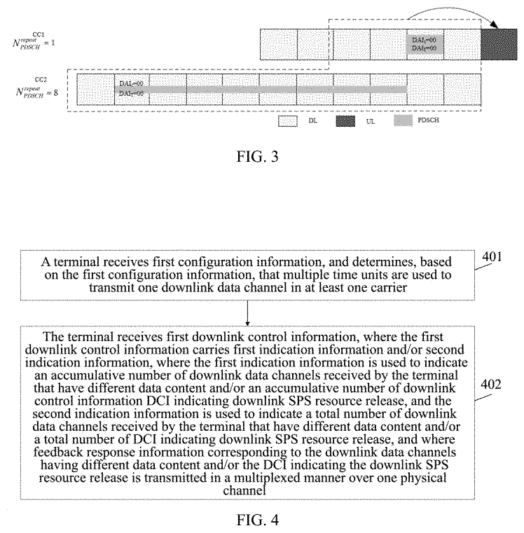

In addition, according to the definition of DAI described above, there may be a misunderstanding between the base station and the UE. As shown in FIG. 3, the upper row represents time units on the carrier 1 (CC1), where the number of PDSCH that is repeatedly transmitted on the CC1 is 1, that is, N_{PDSCH}^{repeat}=1; the lower row represents time units on the carrier 2 (CC2), where the number of PDSCHs that are repeatedly transmitted on the CC2 is 8, that is, N_{PDSCH}^{repeat}=8, the DAI information field is 2 bits in length. When the base station has PDSCH scheduling as shown in FIG. 3, the base station expects the UE to feedback 9 bits of information. If the UE does not successfully receive the DCI on the CC2 but only receives the DCI on the CC1, the UE only feeds back 1 bit of information. A similar problem will occur for a transmitting condition that the UE consecutively misses an integer multiple of 4 DCIs when the slot aggregation is not used, but this case has a very low probability. However, when the slot aggregation is used, if one DCI is missed, this problem will occur, which will seriously affect system performance.

FIG. 4 is a schematic flowchart 1 of an information transmission method according to an embodiment of the present application. As shown in FIG. 4, the information transmission method includes the following steps:

Step 401: a terminal receives first configuration information, and determines, based on the first configuration information, that multiple time units are used to transmit one downlink data channel in at least one carrier.

In the embodiment of the present application, the terminal may be any device that can communicate with a network, such as a mobile phone, a tablet computer, a vehicle-mounted terminal, a notebook and the like.

In the embodiment of the present application, the terminal may communicate with the network via one carrier and multiple carriers, in further, the terminal receives the first configuration information, and determines, based on the first configuration information, that multiple time units are used to transmit one downlink data channel in at least one carrier.

For example, the network side configures the terminal with two carriers through the first configuration information, which are a CC1 and a CC2, respectively. On the CC1, one time unit is used to transmit one downlink data channel, and description is made by taking an example where the downlink data channel is a PDSCH, N_{PDSCH}^{repeat}=1; while on the CC2, three time units are used to transmit one downlink data channel, and description is made by taking an example where the downlink data channel is a PDSCH, N_{PDSCH}^{repeat}=3.

In the above example, multiple time units are used to transmit one downlink data channel on one of the two carriers, but the description is not limited thereto. According to requirements, the network side may configure the two carriers so that multiple time units are used to transmit one downlink data channel on both of the two carries.

In the embodiment of the present application, the network side configures one or more carriers so that multiple time units are used to transmit one downlink data channel on the one or more carriers, that is, the carrier(s) is configured as a slot aggregation carrier, on which the terminal uses a slot aggregation mode to transmit the downlink data channel.

Step 402: the terminal receives first downlink control information, where the first downlink control information carries first indication information and/or second indication information, where the first indication information is used to indicate an accumulative number of downlink data channels received by the terminal that have different data content and/or an accumulative number of downlink control information DCI indicating downlink SPS resource release, and the second indication information is used to indicate a total number of downlink data channels received by the terminal that have different data content and/or a total number of DCI indicating downlink SPS resource release, and where feedback response information corresponding to the downlink data channels having different data content and/or the DCI indicating the downlink SPS resource release is transmitted in a multiplexed manner over one physical channel.

In the embodiment of the present application, the first indication information corresponds to a counter DAI, the second indication information corresponds to a total DAI, the accumulative number indicated by the first indication information is directed to downlink data channels having different data content and/or downlink control information DCI indicating SPS resource release, similarly, the total number indicated by the second indication information is directed to downlink data channels having different data content and/or downlink control information DCI indicating SPS resource release.

In one example, the first indication information and the second indication information are represented by two bits.

In the embodiment of the present application, different data content may be embodied by TBs or HARQ processes. These two implementations are described separately below.

Mode 1: TB

1) The first indication information is used to indicate an accumulative number of downlink data channels received by the terminal that carry different transport blocks (TBs).

In this case, multiple downlink data channels over which a same TB is transmitted correspond to the same first indication information.

2) The second indication information is used to indicate a total number of downlink data channels received by the terminal that carry different TBs.

In this case, for the total number indicated by the second indication information, multiple downlink data channels over which a same TB is transmitted are counted once.

Mode 2: HARQ Process

1) The first indication information is used to indicate an accumulative number of downlink data channels received by the terminal that are corresponding to different hybrid automatic repeat request (HARQ) processes.

In this case, multiple downlink data channels corresponding to a same HARQ process correspond to the same first indication information.

2) The second indication information is used to indicate a total number of downlink data channels received by the terminal that are corresponding to different HARQ processes.

In this case, for the total number indicated by the second indication information, multiple downlink data channels corresponding to a same HARQ process are counted once.

In the embodiment of the present application, the downlink data channel is transmitted by a target resource unit which is determined by carrier information and downlink channel monitoring occasion information. Further, at least one of carrier information and downlink channel monitoring occasion information corresponding to different downlink data channels is different.

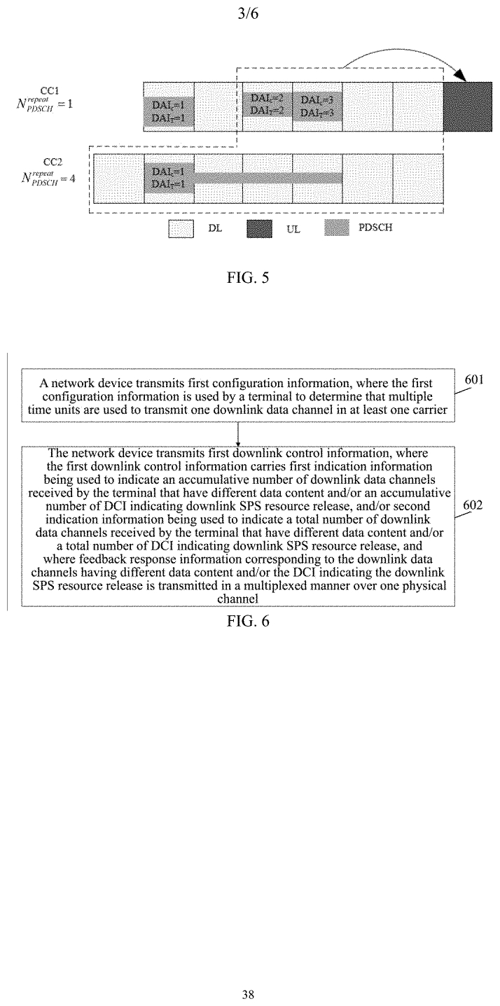

With reference to FIG. 5, the upper row represents time units on a carrier 1 (CC1), where the number of PDSCH that is repeatedly transmitted on the CC1 is 1, that is, N_{PDSCH}^{repeat}=1; the lower row represents time units on a carrier 2 (CC2), where the number of PDSCHs that are repeatedly transmitted on the CC2 is 4, that is, N_{PDSCH}^{repeat}=4. According to the definition of DAI in the embodiment of the present application, the terminal needs to feedback 3 bits of ACK/NACK information in an uplink (UL) time unit, where the four identical PDSCHs that are repeatedly transmitted on the CC2 correspond to 1 bit of ACK/NACK information, and uplink control overheads are significantly saved compared to a situation where four identical PDSCHs correspond to 4 bits of ACK/NACK information.

In the solution described above according to the embodiment of the present application, the granularity of the time unit may be a sub-frame, or a slot, or an sTTI, or other fixed time length.

It should be clarified that the first indication information in the embodiment of the present application can be used not only to indicate the accumulative number of downlink data channels received by the terminal that have different data content, but also to indicate the accumulative number of DCI indicating SPS resource release. Similarly, the second indication information in the embodiment of the present application can be used not only to indicate the total number of downlink data channels received by the terminal that have different data content, but also to indicate the total number of DCI indicating SPS resource release.

FIG. 6 is a schematic flowchart 2 of an information transmission method according to an embodiment of the present application. As shown in FIG. 6, the information transmission method includes the following steps:

Step 601: a network device transmits first configuration information, where the first configuration information is used by a terminal to determine that multiple time units are used to transmit one downlink data channel in at least one carrier.

In the embodiment of the present application, the network device may be a base station, such as a gNB in 5G or an eNB in 4G. The network device transmits the first configuration information to the terminal. Here, the terminal may be any device that can communicate with a network, such as a mobile phone, a tablet computer, a vehicle-mounted terminal, a notebook and the like. In the embodiment of the present application, the terminal may communicate with the network via one carrier and multiple carriers.

For example, the network side configures the terminal with two carriers through the first configuration information, which are a CC1 and a CC2, respectively. On the CC1, one time unit is used to transmit one downlink data channel, and description is made by taking an example where the downlink data channel is a PDSCH, N_{PDSCH}^{repeat}=1; while on the CC2, three time units are used to transmit one downlink data channel, and description is made by taking an example where the downlink data channel is a PDSCH, N_{PDSCH}^{repeat}=3.

In the above example, multiple time units are used to transmit one downlink data channel on one of the two carriers, but the description is not limited thereto. According to requirements, the network side may configure the two carriers so that multiple time units are used to transmit one downlink data channel on both of the two carries.

In the embodiment of the present application, the network side configures one or more carriers so that multiple time units are used to transmit one downlink data channel on the one or more carriers, that is, the carrier(s) is configured as a slot aggregation carrier, on which the terminal uses a slot aggregation mode to transmit the downlink data channel.

Step 602: the network device transmits first downlink control information, where the first downlink control information carries first indication information and/or second indication information, where the first indication information is used to indicate an accumulative number of downlink data channels received by the terminal that have different data content and/or an accumulative number of DCI indicating downlink SPS resource release, and the second indication information is used to indicate a total number of downlink data channels received by the terminal that have different data content and/or a total number of DCI indicating downlink SPS resource release, and where feedback response information corresponding to the downlink data channels having different data content and/or the DCI indicating the downlink SPS resource release is transmitted in a multiplexed manner over one physical channel.

In the embodiment of the present application, the first indication information corresponds to a counter DAI, the second indication information corresponds to a total DAI, the accumulative number indicated by the first indication information is directed to downlink data channels having different data content and/or downlink control information DCI indicating SPS resource release, similarly, the total number indicated by the second indication information is directed to downlink data channels having different data content and/or downlink control information DCI indicating SPS resource release.

In one example, the first indication information and the second indication information are represented by two bits.

In the embodiment of the present application, different data content may be embodied by TBs or HARQ processes. These two implementations are described separately below.

Mode 1: TB

1) The first indication information is used to indicate an accumulative number of downlink data channels received by the terminal that carry different transport blocks (TBs).

In this case, multiple downlink data channels over which a same TB is transmitted correspond to the same first indication information.

2) The second indication information is used to indicate a total number of downlink data channels received by the terminal that carry different TBs.

In this case, for the total number indicated by the second indication information, multiple downlink data channels over which a same TB is transmitted are counted once.

Mode 2: HARQ Process

1) The first indication information is used to indicate an accumulative number of downlink data channels received by the terminal that are corresponding to different hybrid automatic repeat request (HARQ) processes.

In this case, multiple downlink data channels corresponding to a same HARQ process correspond to the same first indication information.

2) The second indication information is used to indicate a total number of downlink data channels received by the terminal that are corresponding to different HARQ processes.

In this case, for the total number indicated by the second indication information, multiple downlink data channels corresponding to a same HARQ process are counted once.

In the embodiment of the present application, the downlink data channel is transmitted by a target resource unit which is determined by carrier information and downlink channel monitoring occasion information. Further, at least one of carrier information and downlink channel monitoring occasion information corresponding to different downlink data channels is different.

With reference to FIG. 5, the upper row represents time units on a carrier 1 (CC1), where the number of PDSCH that is repeatedly transmitted on CC1 is 1, that is, N_{PDSCH}^{repeat}=1; the lower row represents time units on a carrier 2 (CC2), where the number of PDSCHs that are repeatedly transmitted on CC2 is 4, that is, N_{PDSCH}^{repeat}=4. According to the definition of DAI in the embodiment of the present application, the terminal needs to feedback 3 bits of ACK/NACK information in an uplink (UL) time unit, where four identical PDSCHs that are repeatedly transmitted on CC2 correspond to 1 bit of ACK/NACK information, and uplink control overheads are significantly saved compared to a situation where four identical PDSCHs correspond to 4 bits of ACK/NACK information.

In the solution described above according to the embodiment of the present application, the granularity of the time unit may be a sub-frame, or a slot, or an sTTI, or other fixed time length.

It should be clarified that the first indication information in the embodiment of the present application can be used not only to indicate the accumulative number of downlink data channels received by the terminal that have different data content, but also to indicate the accumulative number of DCI indicating SPS resource release. Similarly, the second indication information in the embodiment of the present application can be used not only to indicate the total number of downlink data channels received by the terminal that have different data content, but also to indicate the total number of DCI indicating SPS resource release.

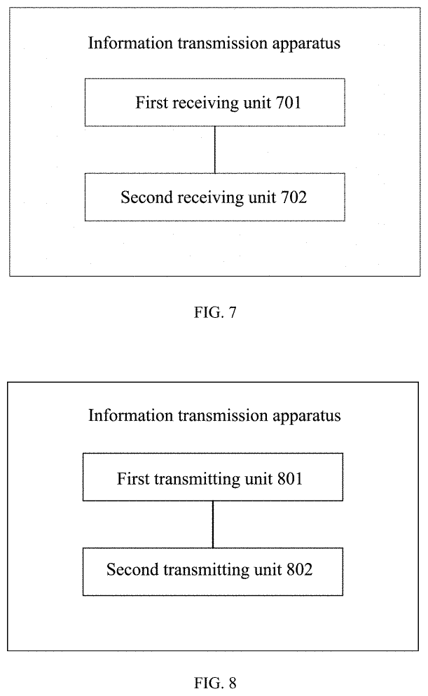

FIG. 7 is a schematic structural diagram 1 of an information transmission apparatus according to an embodiment of the present application. As shown in FIG. 7, the apparatus includes:

a first receiving unit 701, configured to receive first configuration information, and determine, based on the first configuration information, that multiple time units are used to transmit one downlink data channel in at least one carrier; and

a second receiving unit 702, configured to receive first downlink control information, where the first downlink control information carries first indication information and/or second indication information, where the first indication information is used to indicate an accumulative number of downlink data channels received by a terminal that have different data content and/or an accumulative number of DCI indicating downlink SPS resource release, and the second indication information is used to indicate a total number of downlink data channels received by the terminal that have different data content and/or a total number of DCI indicating downlink SPS resource release, and wherein feedback response information corresponding to the downlink data channels having different data content and/or the DCI indicating the downlink SPS resource release is transmitted in a multiplexed manner over one physical channel.

In an implementation, the first indication information being used to indicate an accumulative number of downlink data channels received by the terminal that have different data content includes:

the first indication information is used to indicate an accumulative number of downlink data channels received by the terminal that carry different TBs.

In an implementation, corresponding to the first indication information being used to indicate an accumulative number of downlink data channels received by the terminal that have different data content, multiple downlink data channels over which a same TB is transmitted correspond to the same first indication information.

In an implementation, the second indication information being used to indicate a total number of downlink data channels received by the terminal that have different data content includes:

the second indication information is used to indicate a total number of downlink data channels received by the terminal that carry different TBs.

In an implementation, corresponding to the second indication information being used to indicate a total number of downlink data channels received by the terminal that have different data content, for the total number indicated by the second indication information, multiple downlink data channels over which a same TB is transmitted are counted once.

In an implementation, the first indication information being used to indicate an accumulative number of downlink data channels received by the terminal that have different data content includes:

the first indication information is used to indicate an accumulative number of downlink data channels received by the terminal that are corresponding to different HARQ processes.

In an implementation, corresponding to the first indication information being used to indicate an accumulative number of downlink data channels received by the terminal that have different data content, multiple downlink data channels corresponding to a same HARQ process correspond to the same first indication information.

In an implementation, the second indication information being used to indicate a total number of downlink data channels received by the terminal that have different data content includes:

the second indication information is used to indicate a total number of downlink data channels received by the terminal that are corresponding to different HARQ processes.

In an implementation, corresponding to the second indication information being used to indicate a total number of downlink data channels received by the terminal that have different data content, for the total number indicated by the second indication information, multiple downlink data channels corresponding to a same HARQ process are counted once.

In an implementation, the downlink data channel is transmitted by a target resource unit which is determined by carrier information and downlink channel monitoring occasion information.

In an implementation, at least one of carrier information and downlink channel monitoring occasion information corresponding to different downlink data channels is different.

Persons skilled in the art should understand that, for related description of the information transmission apparatus described above in the embodiment of the present application, reference may be made to related description of the information transmission method in the embodiment of the present application.

FIG. 8 is a schematic structural diagram 2 of an information transmission apparatus according to an embodiment of the present application. As shown in FIG. 8, the apparatus includes:

a first transmitting unit 801, configured to transmit first configuration information, wherein the first configuration information is used by a terminal to determine that multiple time units are used to transmit one downlink data channel in at least one carrier; and

a second transmitting unit 802, configured to transmit first downlink control information, where the first downlink control information carries first indication information and/or second indication information, where the first indication information is used to indicate an accumulative number of downlink data channels received by the terminal that have different data content and/or an accumulative number of DCI indicating downlink SPS resource release, and the second indication information is used to indicate a total number of downlink data channels received by the terminal that have different data content and/or a total number of DCI indicating downlink SPS resource release, and wherein feedback response information corresponding to the downlink data channels having different data content and/or the DCI indicating the downlink SPS resource release is transmitted in a multiplexed manner over one physical channel.

In an implementation, the first indication information being used to indicate an accumulative number of downlink data channels received by the terminal that have different data content includes:

the first indication information is used to indicate an accumulative number of downlink data channels received by the terminal that carry different TBs.

In an implementation, corresponding to the first indication information being used to indicate an accumulative number of downlink data channels received by the terminal that have different data content, multiple downlink data channels over which a same TB is transmitted correspond to the same first indication information.

In an implementation, the second indication information being used to indicate a total number of downlink data channels received by the terminal that have different data content includes:

the second indication information is used to indicate a total number of downlink data channels received by the terminal that carry different TBs.

In an implementation, corresponding to the second indication information being used to indicate a total number of downlink data channels received by the terminal that have different data content, for the total number indicated by the second indication information, multiple downlink data channels over which a same TB is transmitted are counted once.

In an implementation, the first indication information being used to indicate an accumulative number of downlink data channels received by the terminal that have different data content includes:

the first indication information is used to indicate an accumulative number of downlink data channels received by the terminal that are corresponding to different HARQ processes.

In an implementation, corresponding to the first indication information being used to indicate an accumulative number of downlink data channels received by the terminal that have different data content, multiple downlink data channels corresponding to a same HARQ process correspond to the same first indication information.

In an implementation, the second indication information being used to indicate a total number of downlink data channels received by the terminal that have different data content includes:

the second indication information is used to indicate a total number of downlink data channels received by the terminal that are corresponding to different HARQ processes.

In an implementation, corresponding to the second indication information being used to indicate a total number of downlink data channels received by the terminal that have different data content, for the total number indicated by the second indication information, multiple downlink data channels corresponding to a same HARQ process are counted once.

In an implementation, the downlink data channel is transmitted by a target resource unit which is determined by carrier information and downlink channel monitoring occasion information.

In an implementation, at least one of carrier information and downlink channel monitoring occasion information corresponding to different downlink data channels is different.

Persons skilled in the art should understand that, for related description of the information transmission apparatus described above in the embodiment of the present application, reference may be made to related description of the information transmission method in the embodiment of the present application.

FIG. 9 is a schematic structural diagram of a communication device 600 according to an embodiment of the present application. The communication device may be a terminal or a network device. The communication device 600 shown in FIG. 9 includes a processor 610 which may invoke and run a computer program from a memory to implement the methods in the embodiments of the present application.

In an implementation, as shown in FIG. 9, the communication device 600 may further include a memory 620. The processor 610 may invoke and run a computer program from the memory 620 to implement the methods in the embodiments of the present application.

The memory 620 may be a separate device independent of the processor 610 or may be integrated in the processor 610.

In an implementation, as shown in FIG. 9, the communication device 600 may further include a transceiver 630. The processor 610 may control the transceiver 630 to communicate with other device, in particular, to transmit information or data to other device, or receive information or data transmitted by other device.

The transceiver 630 may include a transmitter and a receiver. The transceiver 630 may further include an antenna, and the number of antennas may be one or more.

In an implementation, the communication device 600 may be specifically the network device in the embodiment of the present application, and the communication device 600 may implement corresponding processes implemented by the network device in the method of the embodiment of the present application. For brevity, details will not be described herein again.

In an implementation, the communication device 600 may be specifically the mobile terminal/the terminal in the embodiment of the present application, and the communication device 600 may implement corresponding processes implemented by the mobile terminal/the terminal in the method of the embodiment of the present application. For brevity, details will not be described herein again.

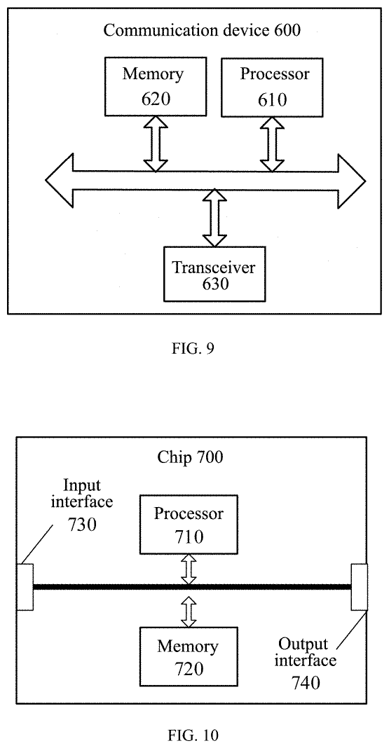

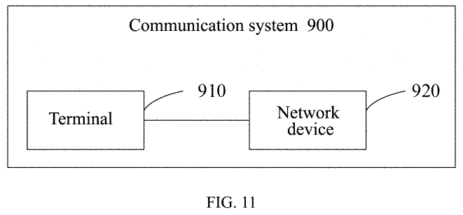

FIG. 10 is a schematic structural diagram of a chip according to an embodiment of the present application. The chip 700 shown in FIG. 10 includes a processor 710 which may invoke and run a computer program from a memory to implement the method in the embodiment of the present application.

In an implementation, as shown in FIG. 10, the chip 700 may further include a memory 720. The processor 710 may invoke and run a computer program from the memory 720 to implement the method in the embodiment of the present application.

The memory 720 may be a separate device independent of the processor 710 or may be integrated in the processor 710.

In an implementation, the chip 700 may also include an input interface 730. The processor 710 may control the input interface 730 to communicate with other device or chip, in particular, to acquire information or data transmitted by other device or chip.

In an implementation, the chip 700 may further include an output interface 740. The processor 710 may control the output interface 740 to communicate with other device or chip, in particular, to output information or data to other device or chip.

In an implementation, the chip can be applied to the network device in the embodiment of the present application, and the chip may perform corresponding processes implemented by the network device in the method of the embodiment of the present application. For brevity, details will not be described herein again.

In an implementation, the chip can be applied to the mobile terminal/the terminal in the embodiment of the present application, and the chip may perform corresponding processes implemented by the mobile terminal/the terminal in the method of the embodiment of the present application. For brevity, details will not be described herein again.

It should be understood that the chip mentioned in the embodiment of the present application may also be referred to as a system level chip, a system chip, a chip system or a system-on-chip.

FIG. 11 is a schematic block diagram of a communication system 900 according to an embodiment of the present application. As shown in FIG. 11, the communication system 900 includes a terminal 910 and a network device 920.

The terminal 910 may be configured to implement corresponding functions implemented by the terminal in the foregoing method; moreover, the network device 920 may be configured to implement corresponding functions implemented by the network device in the foregoing method. For brevity, details will not be described herein again.

It should be understood that the processor in the embodiment of the present application may be an integrated circuit chip with signal processing capabilities. During implementations, each step of the foregoing method embodiments may be achieved by an integrated logic circuit of hardware in the processor or an instruction in a form of software. The above processor may be a general purpose processor, a digital signal processor (DSP), an application specific integrated circuit (ASIC), a field programmable gate array (FPGA) or other programmable logic device, discrete gate transistor logic device, or discrete hardware component. The methods, steps, and logical block diagrams disclosed in the embodiments of the present application may be implemented or performed. The general purpose processor may be a microprocessor; alternatively, the processor may also be any conventional processor or the like. The steps of the methods disclosed in the embodiments of the present application may be directly implemented by a hardware decoding processor, or may be performed by a combination of hardware and software modules in the decoding processor. The software module may be located in a storage medium mature in the art, such as a random access memory, a flash memory, a read only memory, a programmable read only memory, an electrically erasable programmable memory, a register, or the like. The storage medium is located in the memory. The processor reads information in the memory and performs the steps of the above methods in combination with its hardware.

It can be understood that the memory in the embodiment of the present application may be a volatile memory or a non-volatile memory, or may include both the volatile memory and the non-volatile memory. The non-volatile memory may be a read-only memory (ROM), a programmable ROM (PROM), or an erasable PROM (EPROM), an electrically EPROM (EEPROM) or a flash memory. The volatile memory may be a random access memory (RAM), which is used as an external cache. By way of exemplary but not restrictive illustration, many forms of RAMs can be used, such as a static RAM (SRAM), a dynamic RAM (DRAM), a synchronous DRAM (SDRAM), a double data rate SDRAM (DDR SDRAM), an enhanced SDRAM (ESDRAM), a synchlink DRAM (SLDRAM) and a direct rambus RAM (DR RAM). It should be noted that the memory in the system and method described herein is intended to include, but are not limited to these and any other suitable types of memories.

It should be understood that the foregoing memory is exemplary but not restrictive illustration. For example, the memory in the embodiment of the present application may also be a static RAM (SRAM), a dynamic RAM (DRAM), a synchronous DRAM (SDRAM), a double data rate SDRAM (DDR SDRAM), an enhanced SDRAM (ESDRAM), a synch link DRAM (SLDRAM) and a Direct Rambus RAM (DR RAM). That is, the memory in the embodiment of the present application is intended to include, but is not limited to these and any other suitable types of memories.

An embodiment of the present application further provides a computer readable storage medium which is configured to store a computer program.

In an implementation, the computer readable storage medium can be applied to the network device in the embodiment of the present application, and the computer program causes a computer to perform corresponding processes implemented by the network device in the method of the embodiment of the present application. For brevity, details will not be described herein again.

In an implementation, the computer readable storage medium can be applied to the mobile terminal/the terminal in the embodiment of the present application, and the computer program causes a computer to perform corresponding processes implemented by the mobile terminal/the terminal in the method of the embodiment of the present application. For brevity, details will not be described herein again.

An embodiment of the present application further provides a computer program product including a computer program instruction.

In an implementation, the computer program product can be applied to the network device in the embodiment of the present application, and the computer program instruction causes a computer to perform corresponding processes implemented by the network device in the method of the embodiment of the present application. For brevity, details will not be described herein again.

In an implementation, the computer program product can be applied to the mobile terminal/the terminal in the embodiment of the present application, and the computer program instruction causes a computer to perform corresponding processes implemented by the mobile terminal/the terminal in the method of the embodiment of the present application. For brevity, details will not be described herein again.

An embodiment of the present application further provides a computer program.

In an implementation, the computer program can be applied to the network device in the embodiment of the present application. When running on a computer, the computer program causes the computer to perform corresponding processes implemented by the network device in the method of the embodiment of the present application. For brevity, details will not be described herein again.

In an implementation, the computer program can be applied to the mobile terminal/the terminal in the embodiment of the present application. When running on a computer, the computer program causes the computer to perform corresponding processes implemented by the mobile terminal/the terminal in the method of the embodiment of the present application. For brevity, details will not be described herein again.

It may be known to persons of ordinary skill in the art that, the units and the algorithm steps of each example that are described with reference to the embodiments disclosed herein can be implemented by electronic hardware or a combination of electronic hardware and computer software. Whether these functions are performed by hardware or software depends on specific applications and design constraints of the technical solutions. Persons skilled in the art may implement the described functions by using different methods for each specific application, but such implementation should not be regarded as going beyond the scope of the present application.

It may be clearly understood by a person skilled in the art that, for the purpose of convenient and brief description, reference may be made to the corresponding processes in the foregoing method embodiments for detailed working processes of the foregoing systems, apparatuses, and units, and details will not be described herein again.

In several embodiments provided in the present application, it should be understood that the disclosed systems, apparatuses, and methods may be implemented in other manners. For example, the described apparatus embodiments are merely exemplary. For instance, the division of the units is merely a division of logical functions and there may be other division manners in actual implementations. For instance, multiple units or components may be combined or integrated into another system, or some features may be omitted or not performed. In addition, the presented or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts shown as units may or may not be physical units, that is, may be located in one position, or may be distributed on multiple network units. A part or all of the units may be selected according to actual needs to achieve the objectives of the solutions in the embodiments.

In addition, functional units in the embodiments of the present application may be integrated into one processing unit, or each of the units may exist separately in physical, or two or more units are integrated into one unit.

If implemented in a form of a software functional unit and sold or used as an independent product, the functions may be stored in a computer readable storage medium. Based on such understanding, the technical solutions of the essence of the present application, or the part contributing to the prior art, or a part of the technical solutions may be implemented in a form of a software product. The computer software product is stored in a storage medium, and includes several instructions for enabling a computer device (which may be a personal computer, a server, or a network device, etc.) to perform all or a part of the steps of the methods described in the embodiments of the present application. The foregoing storage medium includes: any medium that can store program codes, such as a USB flash disk, a mobile hard disk, a read-only memory (ROM), a random access memory (RAM), a magnetic disk, or an optical disc, etc.

The above descriptions are merely specific embodiments of the present application; however, the protection scope of the present application is not limited thereto. Any modification or replacement that may be readily conceived by persons skilled in the art within the technical scope disclosed in the present application should fall into the protection scope of the present application. Therefore, the protection scope of the present application shall be subject to the claims.

What is claimed is:

1. An information transmission method, comprising:
receiving, by a terminal, first configuration information, and determining, based on the first configuration information, that multiple time units are used to transmit one downlink data channel in at least one carrier; and
receiving, by the terminal, first downlink control information, wherein the first downlink control information carries at least one of first indication information and second indication information, wherein the first indication information is used to indicate at least one of an accumulative number of downlink data channels received by the terminal that have different data content and an accumulative number of downlink control information (DCI) indicating downlink semi-persistent scheduling (SPS) resource release, and the second indication information is used to indicate at least one of a total number of downlink data channels received by the terminal that have different data content and a total number of DCI indicating downlink SPS resource release, and wherein feedback response information corresponding to at least one of the downlink data channels having different data content and the DCI indicating the downlink SPS resource release is transmitted in a multiplexed manner over one physical channel.

2. The method according to claim 1, wherein the first indication information being used to indicate an accumulative number of downlink data channels received by the terminal that have different data content comprises:
the first indication information is used to indicate an accumulative number of downlink data channels received by the terminal that carry different transport blocks (TBs).

3. The method according to claim 1, wherein corresponding to the first indication information being used to indicate an accumulative number of downlink data channels received by the terminal that have different data content, multiple downlink data channels over which a same TB is transmitted correspond to the same first indication information.

4. The method according to claim 1, wherein the second indication information being used to indicate a total number of downlink data channels received by the terminal that have different data content comprises:
the second indication information is used to indicate a total number of downlink data channels received by the terminal that carry different TBs.

5. The method according to claim 1, wherein corresponding to the second indication information being used to indicate a total number of downlink data channels received by the terminal that have different data content, for the total number indicated by the second indication information, multiple downlink data channels over which a same TB is transmitted are counted once.

6. The method according to claim 1, wherein the first indication information being used to indicate an accumulative number of downlink data channels received by the terminal that have different data content comprises:
the first indication information is used to indicate an accumulative number of downlink data channels received by the terminal that are corresponding to different hybrid automatic repeat request (HARQ) processes.

7. The method according to claim 1, wherein corresponding to the first indication information being used to indicate an accumulative number of downlink data channels received by the terminal that have different data content, multiple downlink data channels corresponding to a same HARQ process correspond to the same first indication information.

8. The method according to claim 1, wherein the second indication information being used to indicate a total number of downlink data channels received by the terminal that have different data content comprises:
the second indication information is used to indicate a total number of downlink data channels received by the terminal that are corresponding to different HARQ processes.

9. An information transmission apparatus, comprising: a processor, a memory and a transceiver, wherein the memory is configured to store a computer program, and the processor is configured to invoke and run the computer program stored in the memory to:
control the transceiver to receive first configuration information, and determine, based on the first configuration information, that multiple time units are used to transmit one downlink data channel in at least one carrier; and
control the transceiver to receive first downlink control information, wherein the first downlink control information carries at least one of first indication information and second indication information, wherein the first indication information is used to indicate at least one of an accumulative number of downlink data channels received by a terminal that have different data content and an accumulative number of DCI indicating downlink SPS resource release, and the second indication information is used to indicate at least one of a total number of downlink data channels received by the terminal that have different data content and a total number of DCI indicating downlink SPS resource release, and wherein feedback response information corresponding to at least one of the downlink data channels having different data content and the DCI indicating the downlink SPS resource release is transmitted in a multiplexed manner over one physical channel.

10. The apparatus according to claim 9, wherein the first indication information being used to indicate an accumulative number of downlink data channels received by the terminal that have different data content comprises:
the first indication information is used to indicate an accumulative number of downlink data channels received by the terminal that carry different TBs.

11. The apparatus according to claim 9, wherein corresponding to the first indication information being used to indicate an accumulative number of downlink data channels received by the terminal that have different data content, multiple downlink data channels over which a same TB is transmitted correspond to the same first indication information.

12. The apparatus according to claim 9, wherein the second indication information being used to indicate a total number of downlink data channels received by the terminal that have different data content comprises:
the second indication information is used to indicate a total number of downlink data channels received by the terminal that carry different TBs.

13. The apparatus according to claim 9, wherein corresponding to the second indication information being used to indicate a total number of downlink data channels received by the terminal that have different data content, for the total number indicated by the second indication information, multiple downlink data channels over which a same TB is transmitted are counted once.

14. The apparatus according to claim 9, wherein the first indication information being used to indicate an accumulative number of downlink data channels received by the terminal that have different data content comprises:
the first indication information is used to indicate an accumulative number of downlink data channels received by the terminal that are corresponding to different HARQ processes.

15. The apparatus according to claim 9, wherein corresponding to the first indication information being used to indicate an accumulative number of downlink data channels received by the terminal that have different data content, multiple downlink data channels corresponding to a same HARQ process correspond to the same first indication information.

16. The apparatus according to claim 9, wherein the second indication information being used to indicate a total number of downlink data channels received by the terminal that have different data content comprises:
the second indication information is used to indicate a total number of downlink data channels received by the terminal that are corresponding to different HARQ processes.

17. The apparatus according to claim 9, wherein corresponding to the second indication information being used to indicate a total number of downlink data channels received by the terminal that have different data content, for the total number indicated by the second indication information, multiple downlink data channels corresponding to a same HARQ process are counted once.

18. The apparatus according to claim 9, wherein the downlink data channel is transmitted by a target resource unit which is determined by carrier information and downlink channel monitoring occasion information.

19. The apparatus according to claim 18, wherein at least one of carrier information and downlink channel monitoring occasion information corresponding to different downlink data channels is different.

20. An information transmission apparatus, comprising: a processor, a memory and a transceiver, wherein the memory is configured to store a computer program, and the processor is configured to invoke and run the computer program stored in the memory to control the transceiver to:
transmit first configuration information, wherein the first configuration information is used by a terminal to determine that multiple time units are used to transmit one downlink data channel in at least one carrier; and
transmit first downlink control information, wherein the first downlink control information carries at least one of first indication information and second indication information, wherein the first indication information is used to indicate at least one of an accumulative number of downlink data channels received by the terminal that have different data content and an accumulative number of DCI indicating downlink SPS resource release, and the second indication information is used to indicate at least one of a total number of downlink data channels received by the terminal that have different data content and a total number of DCI indicating downlink SPS release, and wherein feedback response information corresponding to at least one of the downlink data channels having different data content and the DCI indicating the downlink SPS resource release is transmitted in a multiplexed manner over one physical channel.
